(19) United States
(12) Patent Application Publication
(10) Pub. No.: US 2014/0115097 A1
(43) Pub. Date: Apr. 24, 2014

(54) TRANSMITTING AN EXECUTING APPLICATION

(71) Applicant: INTERNATIONAL BUSINESS MACHINES CORPORATION, Armonk, NY (US)

(72) Inventors: Hector R. Ayala Nieves, San Juan, PR (US); Dale J. Heeks, Cary, NC (US); Jeffrey M. Laubacker, Cary, NC (US); Thomas W. Savage, Chapel Hill, NC (US)

(73) Assignee: INTERNATIONAL BUSINESS MACHINES CORPORATION, Armonk, NY (US)

(21) Appl. No.: 13/659,598

(22) Filed: Oct. 24, 2012

(51) Int. Cl. G06F 15/16

(52) U.S. Cl. 709/217

(57) ABSTRACT

Embodiments of the present invention provide a system, method, and program product for transferring an executing application to a second computer. A first computer includes an executing application, wherein the first computer executes a first cross-platform hypervisor, and wherein the application includes a graphical state and a memory state. The first computing receives a signal to transfer the executing application to the second computer, which is executes a second cross-platform hypervisor, and halts the executing application. The first computer transfers the graphical state and the memory state of the executing application to the second computer, utilizing any suitable protocol capable of transferring the graphical state and the memory of the executing application from the first computer to the second computer, wherein execution of the executing application resumes on the second computer.

### FIELD OF THE INVENTION

The present invention relates generally to the field of application virtualization, and more particularly to transmitting an executing application to a computing device.

### BACKGROUND OF THE INVENTION

Computing relies heavily on distinct mobile computing platforms. Users of such mobile computing platforms (e.g., laptops, desktops, smart phones, etc.,) are regularly switching between these devices throughout each day. The migration from one computing platform to another can cost users time as they find themselves restarting their computing workflow on each new platform. Moreover, a change from a mobile computing platform to another requires users to reinitialize application state on the new platform. Such reinitialization of an application requires that a compatible version of the application has been installed on the target platform. Likewise, the reinitialization of application state must be done by either loading information on a portable media storage device such as a USB thumb drive, writing application information to an optical disc or the like or perhaps downloading the application state from a network source. Any such reinitialization of application state demands more time and effort on the part of the user.

An application executes within a native operating system, which is a collection of software that manages computer hardware resources and provides common services for applications. Operating systems act as an intermediary between applications and the computer hardware (input/output system, graphics drivers, hardware interfaces, and storage); however, the application code is usually executed directly by the hardware. An application may execute within a non-native operating system by the use of a virtual machine manager that emulates the input/output system, graphics drivers, hardware interfaces, and storage of the application's native operating system. A user would benefit from the ability to transfer an executing application in a seamless manner.

### SUMMARY

Embodiments of the present invention provide a system, method, and program product to transfer an executing application to a second computer. A first computer includes an executing application, wherein the first computer executes a first cross-platform hypervisor, and wherein the application includes a graphical state and a memory state. The first computer receives a signal to transfer the executing application to the second computer, which is executes a second cross-platform hypervisor, and halts the executing application. The first computer transfers the graphical state and the memory state of the executing application to the second computer, utilizing any suitable protocol capable of transferring the graphical state and the memory of the executing application from the first computer to the second computer, wherein execution of the executing application resumes on the second computer.

In certain embodiments, the first cross-platform hypervisor is a virtualization manager able to emulate at least a portion of the executing application's native executing environment.

In other embodiments, the portion of the executing application's native executing environment includes an input/output system, graphics driver, hardware interface, processor or storage.

In still other embodiments, the first cross-platform hypervisor is operating system agnostic; the first cross-platform hypervisor is the same as or compatible with the second cross-platform hypervisor.

In additional embodiments, the graphical state of the executing application includes a plurality of graphical icons and/or visual indicators that present information and available actions to a user.

In certain embodiments, the memory state of the executing application includes information pertaining to the running state of the executing process.

In other embodiments, the signal to transfer the executing application includes signals generated by a mouse, keyboard, keypad, capacitive touchscreen, or motion sensing input device.

### BRIEF DESCRIPTION OF THE SEVERAL VIEWS OF THE DRAWINGS

FIG. 1 is a functional block diagram illustrating an executing application transfer environment, in accordance with an embodiment of the present invention, in accordance with an embodiment of the present invention.

FIG. 2 illustrates exemplary transmissions that may occur within the executing application transfer environment of FIG. 1, in accordance with an embodiment of the present invention.

FIG. 3 illustrates the operational steps a hypervisor program, running on a computing device within the executing application transfer environment of FIG. 1, in accordance with an embodiment of the present invention.

FIG. 4 depicts a block diagram of components of the computing device executing the hypervisor program, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.,) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus or other devices to function in a particular manner, such that the instructions stored in the computer-readable medium produce an article of manufacture including instructions, which implement the function/act specified in the flowchart and/or block diagram block or blocks.

The computer program instructions may also be loaded onto a computer, other programmable data processing apparatus or other devices to cause a series of operational steps to be performed on the computer, other programmable apparatus or other devices to produce a computer-implemented process such that the instructions, which execute on the computer or other programmable apparatus provide processes for implementing the functions/acts specified in the flowchart and/or block diagram block or blocks.

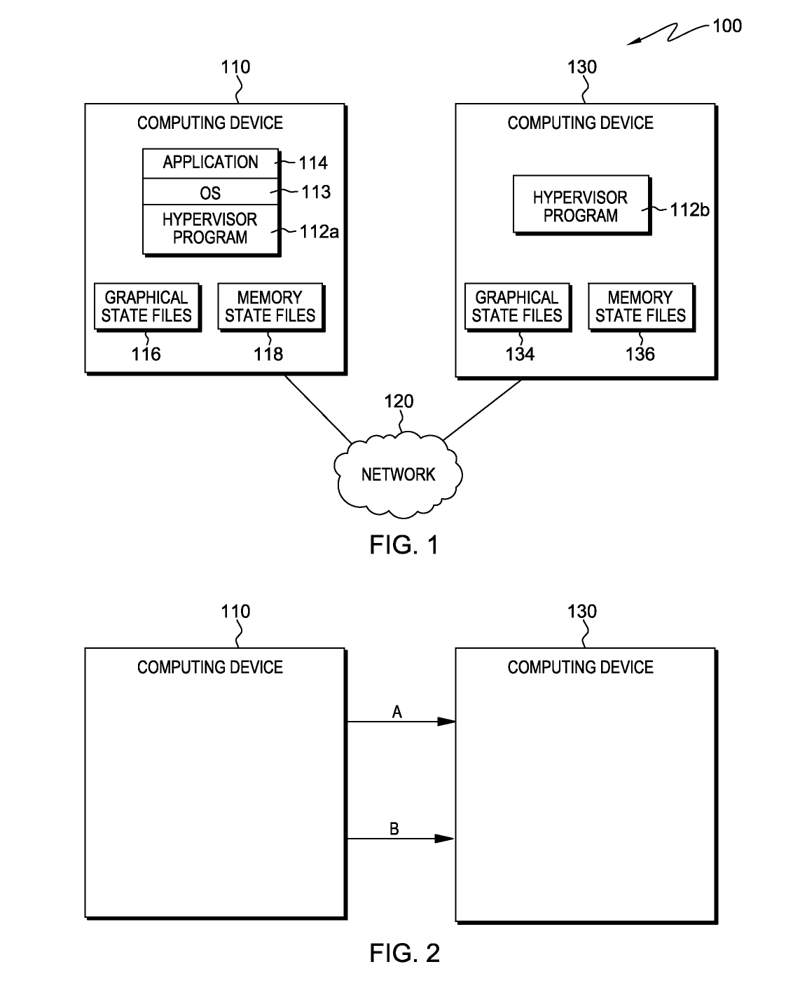

The present invention will now be described in detail with reference to the Figures. FIG. 1 is a functional block diagram illustrating an executing application transfer environment, generally designated 100, in accordance with one embodiment of the current disclosure.

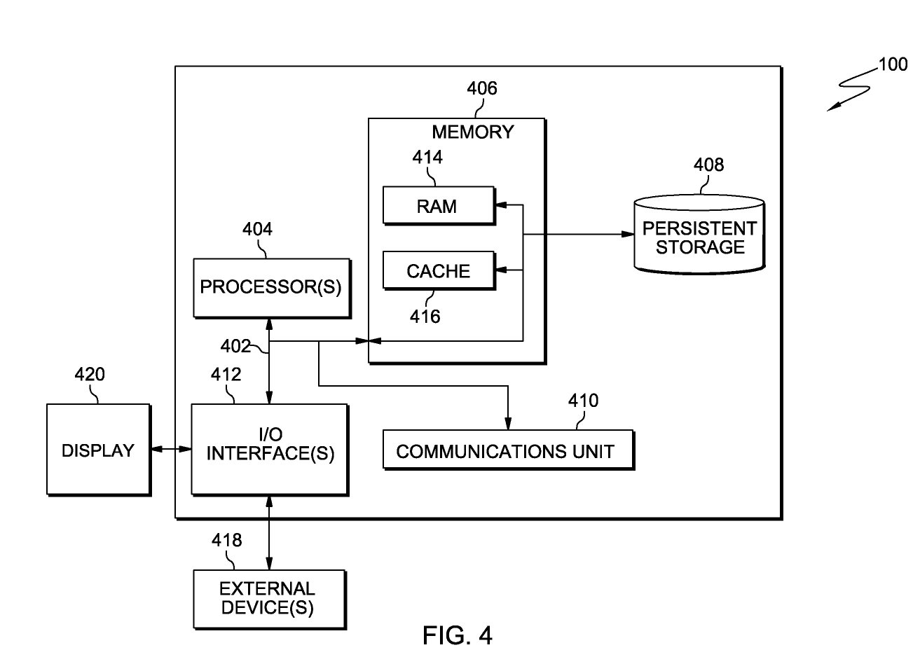

In an embodiment of the present invention, executing application transfer environment 100 includes computing device 110 and computing device 130, interconnected over network 120. Network 120 may be wired, wireless or both, and include, without limitation, one or more local area networks (LANs) and/or wide are networks (WANs). Network 120 can be connected by additional connectivity components other than those depicted in FIG. 1. In general, network 120 can be any combination of connections and protocols that will support communications via various channels between computing device 110 and computing device 130, in accordance with an embodiment of the invention. Computing device 110 and computing device 130 may include internal and external hardware components, as depicted and described in further detail with respect to FIG. 4.

In various embodiments of the present invention, computing device 110 may be a laptop computer, tablet computer, netbook computer, personal computer (PC), a desktop computer, a personal digital assistant (PDA), a smart phone, or any programmable electronic device capable of communicating with computing device 130 via network 120, in accordance with an embodiment of the present invention. In another embodiment, computing device 110 may represent a computing system utilizing clustered computers and components to act as a single pool of seamless resources when accessed through network 120. In general, computing device 110 can be any computing device or a combination of devices capable of communicating with computing device 130 and running hypervisor program 112a. Computing device 110 may include hardware components, as depicted and described in further detail with respect to FIG. 4. Computing device 110 includes application 114, operating system 113, hypervisor program 112a, graphical state files 116, and memory state files 118.

Application 114 may be a computer program that is currently executing within computing device 110, for example, an executing spreadsheet application, in accordance with an embodiment of the present invention. In general, application 114 may be any computer program that is capable of execution on computing device 110. In an embodiment, application 114 can execute within operating system 113. Operating system 113 can be an operating system that executes within a virtual machine manager, for example, hypervisor program 112a. In general, operating system 113 may be any operating system within which an application, for example, application 114, may execute and may itself execute within a virtual machine manager, for example, hypervisor program 112a.

An executing application, for example, application 114 and operating system 113, typically may present information and available actions to a user through a plurality of graphical icons and visual indicators (a graphical state). The graphical state may be stored in memory, for example, memory 406, in accordance with an embodiment of the disclosure. Further, an executing application, for example, application 114 and operating system 113, and the executing application's current activity may be contained in a process, which may occupy a variety of states, one of which is a “running” state. A process enters the running state when the process's instructions are executed by a processor, for example, processor 404, of a computing device or system. Further still, the running state may be stored in memory (memory state), for example, memory 406 discussed in further detail below in reference to FIG. 4.

Hypervisor program 112a can be virtual machine manager software that may emulate and/or manage an application, for example, application 114 and operating system 113, and computer hardware resources (e.g., processor 404, memory 406, communications unit 410, and persistent storage 408) of computing device 110. Further, hypervisor program 112a may be a virtual machine manager that may allow an additional operating system, for example, operating system 113 to run on a host computing device, for example, computing device 110. An operating system, for example, operating system 113, emulated by a virtual machine manager, for example, hypervisor program 112a, is a guest operating system. Further still, hypervisor program 112a may present to a guest operating system, for example, operating system 113, a virtual operating platform consisting of virtual hardware resources, for example, virtual copies of processor 404, memory 406, communications unit 410, persistent storage 408, and may manage the execution of the guest operating system.

In an embodiment, hypervisor program 112a may determine a graphical state of an application executing therein, for example, application 114 and operating system 113, and store the determined graphical state in graphical state files 116. Hypervisor program 112a may determine a memory state of an application executing therein, for example, application 114 and operating system 113, and store the determined memory state in memory state files 118.

In an embodiment, hypervisor program 112a may transmit, for example, via network 120, graphical state files 116 and memory state files 118 to a computing device, for example, computing device 130, for emulation thereon. In another embodiment, hypervisor program 112a may transmit graphical state files 116 and memory state files 118 to computing device 130 while application 114 is still executing on computer device 110. In yet another embodiment, hypervisor program 112a may halt the execution of application 114 prior/subsequent to the transmission of graphical state files 116 and/or memory state files 118 to computing device 130. Hypervisor program 112a may be compatible with or a copy of hypervisor program 112b. In general, hypervisor program 112a may be any virtual machine manager software that may transmit graphical state files and memory state files and emulate and/or manage an application and computer hardware resources.

In accordance with an embodiment of the present invention, computing device 130 may include hypervisor program 112b, graphical state files 134, and memory state files 136. Hypervisor program 112b may be associated with network 120. Similar to hypervisor program 112a discussed above, hypervisor program 112b can be a virtual machine manager software package that may emulate and manage an application and computer hardware resources. In an embodiment, hypervisor program 112b may be compatible with hypervisor program 112a. In another embodiment, hypervisor program 112b can be an identical copy of hypervisor program 112a. Hypervisor program 112b may, via computing device 130, receive a graphical state file, for example, graphical state files 116, and/or a memory state file, for example, memory state files 118, of an executing application, for example, application 114 and operating system 113, from hypervisor program 112a.

In an embodiment, hypervisor program 112b may store a graphical state file received from hypervisor program 112a, via computing device 110, in graphical state files 134. In another embodiment, hypervisor program 112b may store a memory state file received from computing device 110 in memory state files 136. Further, hypervisor program 112b may utilize the received graphical state file, for example, graphical state files 134, and the received memory state file, for example, memory state files 136, to emulate on computing device 130 an application executing on computing device 110, for example, application 114.

Having described an overview of an exemplary operating environment in which embodiments of the present invention may be implemented we turn now to FIG. 2, which illustrates exemplary transmissions that may occur within the executing application transfer environment of FIG. 1, in accordance with an embodiment of the current disclosure.

It should be understood that these and other exchanges described herein are set forth only as examples. Other exchanges and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Many of the functions described herein as being performed by one or more entities may be carried out by hardware, firmware, and/or software.

Here, we begin with a discussion of an exemplary set of transmissions (A and B) that may result when hypervisor program 112a, executing application 114, discovers hypervisor program 112b, and receives a transfer signal indicative of a user's desire to transmit a virtual copy of application 114 to hypervisor program 112b for emulation within the executing application transfer environment of FIG. 1. Transmission A represents a transmission from computing device 110 to computing device 130. In particular, transmission A includes hypervisor program 112a transmitting graphical state files 116, via computing device 110, to computing device 130 wherein it is received by hypervisor program 112b in response to hypervisor program 112a detecting hypervisor program 112b. Transmission A initiates in response to hypervisor program 112a receiving a transfer signal indicative of a desire to transfer application 114, via computing device 110, to computing device 130 for emulation. In response to receiving the transfer signal, hypervisor program 112a determines which files in graphical state files 116 are associated with application 114 and which files are associate with operating system 113. In response to said determination, hypervisor program 112a transmits, via computing device 110, the determined graphical state files to computing device 130 where they are received by hypervisor program 112b for emulation.

Transmission B represents a transmission from computing device 110 to computing device 130. In particular, transmission B includes hypervisor program 112a, via computing device 110, transmitting memory state files 118 to hypervisor program 112b, via computing device 130. Transmission B initiates in response to hypervisor program 112a transmitting the determined graphical state files to computing device 130. In response to transmitting the determined graphical state files, hypervisor program 112a determines which files included in memory state files 118 are associated with application 114 and which are associated with operating system 113. In response to said determination, hypervisor program 112a transmits the determined memory state files, via computing device 110, to computing device 130 where they are received by hypervisor program 112b for emulation. In response to receiving the determined graphical state files and the determined memory state files, hypervisor program 112b resumes the execution of application 114 on computing device 130. In response to hypervisor program 112a successfully transmitting both the graphical state and the memory state to hypervisor program 112b, hypervisor program 112a terminates execution of application 114 on computing device 110.

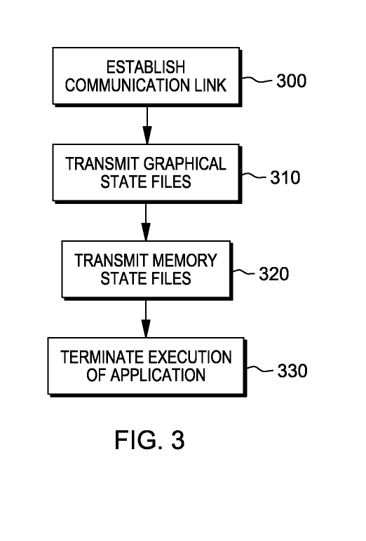

Having described exemplary transmission that may occur within the executing application transfer environment of FIG. 1, an exemplary method for transferring an executing application is described below in relation to FIG. 3, in accordance with an embodiment of the present invention.

FIG. 3 illustrates the operational steps a hypervisor program, running on a computing device within the executing application transfer environment of FIG. 1, takes for transferring an executing application, in accordance with an embodiment of the present invention. Hypervisor program 112a establishes, via computing device 110, a communications link with computing device 130 to send files to hypervisor program 112b (step 300). For example, the transfer signal may be a signal generated by a mouse, keyboard, capacitive touchscreen, or motion sensing input device, indicative of a desire to transfer the execution of application 114 to hypervisor program 112b. For example, said transfer signal may include a user dragging the graphical display of executing application 114 to the edge of the display screen, for example, display 420, or sliding the graphical display of executing application 114 off the display screen. Hypervisor program 112a transmits graphical state files 116 to hypervisor program 112b (step 310). Hypervisor program 112a transmits memory state files 118 to hypervisor program 112b (step 320). In an embodiment, hypervisor program 112a may include both graphical state files 116 and memory state files 118 in the same transmission to hypervisor program 112b. In yet another embodiment, hypervisor program 112a may transmit memory state files 118 to computing device 130 prior to transmitting graphical state files 116 to computing device 130. Hypervisor program 112a terminates execution of application 114 (step 330). In an embodiment, application 114 may continue to execute on hypervisor program 112a subsequent to hypervisor program 112a transmitting graphical state files 116 and memory state files 118 to hypervisor program 112b.

FIG. 4 depicts a block diagram of components included in both computing device 110 and computing device 130 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 110 and computing device 130 each include communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Hypervisor program 112a and graphical state files 116 of computing device 110 may be stored in persistent storage 408 for execution and/or access by one or more of the respective computer processors 404 via one or more memories of memory 406. In the same vein, hypervisor program 112b and graphical state files 134 of computing device 130 may be stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other computing devices, including computing device 110, and computing device 130. In these examples, communications unit 410 includes one or more network interface cards. Communications unit 410 may provide communications through the use of either or both physical and wireless communications links. Hypervisor program 112a and graphical state files 116 of computing device 110 may be downloaded to persistent storage 408 through communications unit 410. In the same vein, hypervisor program 112b and graphical state files 134 of computing device 130 may be downloaded to persistent storage 408 through communications unit 410.

I/O interface(s) 412 allows for input and output of data with other devices that may be connected to server computer 102. For example, I/O interface 412 may provide a connection to external devices 418 such as a keyboard, keypad, mouse, a touch screen, and/or some other suitable input device. External devices 418 can also include portable computer-readable storage media such as, for example, thumb drives, portable optical or magnetic disks, and memory cards. Software and data used to practice embodiments of the present invention, e.g., hypervisor program 112a and hypervisor program 112b, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for a transferring an executing application to a second computing computer, the method comprising:
a first computer including an executing application, wherein the first computer is executing a first cross-platform hypervisor, and wherein the executing application includes a graphical state and a memory state;
the first computer halting the executing application;
the first computer receiving a signal to transfer the executing application to a second computer, wherein the second computing device is executing a second cross-platform hypervisor;
the first computer transferring the graphical state of the executing application to the second computer, wherein the transferring the graphical state may utilize any suitable protocol capable of transferring the graphical state of the executing application from the first computer to the second computer; and
the first computer transferring the memory state of the executing application to the second computer, wherein the transferring the memory state may utilize any suitable protocol capable of transferring the memory state of the application from the first computer to the second computer, and wherein execution of the executing application resumes on the second computer.

2. The method of claim 1, wherein the first cross-platform hypervisor is a virtualization manager that is able to emulate at least a portion of the executing application's native executing environment.

3. The method of claim 2, wherein the portion of the executing application's native executing environment includes an input/output system, graphics driver, hardware interface, processor, or storage.

4. The method of claim 1, wherein the first cross-platform hypervisor is operating system agnostic.

5. The method of claim 1, wherein the first cross-platform hypervisor is identical to or compatible with the second cross-platform hypervisor.

6. The method of claim 1, wherein the graphical state of the executing application includes a plurality of graphical icons and/or visual indicators that present information and available actions to a user.

7. The method of claim 1, wherein the memory state of the executing application includes information pertaining to a running state of the executing application.

8. The method of claim 1, wherein the signal to transfer the executing application includes signals generated by a mouse, keyboard, keypad, capacitive touchscreen, or motion sensing input device.

9. A computer system to transfer an executing application to a second computer, the computer system comprising:
one or more processors, one or more computer-readable memories, one or more computer-readable storage devices, and program instructions stored on at least one of the one more storage devices for execution by at least one of the one or more processors via at least one of the one or more memories, the program instructions comprising:
program instructions to halt an executing application on a first computer, wherein the first computer is executing a first cross-platform hypervisor, and wherein the executing application includes a graphical state and a memory state;
program instructions to receive a signal to transfer the executing application to a second computer, wherein the second computer is executing a second cross-platform hypervisor;
program instructions to transfer the graphical state of the executing application to the second computer, wherein the transfer of the graphical state may utilize any suitable protocol capable of transferring the graphical state of the executing application from the first computer to the second computer; and
program instructions to transfer the memory state of the executing application to the second computer, wherein the transfer of the memory state may utilize any suitable protocol capable of transferring the memory state of the application from the first computer to the second computer, and wherein execution of the executing application resumes on the second computer.

10. The computer system of claim 9, wherein the first cross-platform hypervisor is a virtualization manager that is able to emulate at least a portion of the executing application's native executing environment.

11. The computer system of claim 10, wherein the portion of the executing application's native executing environment includes an input/output system, graphics driver, hardware interface, processor or storage.

12. The computer system of claim 9, wherein the first cross-platform hypervisor is operating system agnostic.

13. The computer system of claim 9, wherein the first cross-platform hypervisor is identical to or compatible with the second cross-platform hypervisor.

14. The computer system of claim 9, wherein the graphical state of the executing application includes a plurality of graphical icons and/or visual indicators that present information and available actions to a user.

15. The computer system of claim 9, wherein the memory state of the executing application includes information pertaining to a running state of the executing application.

16. The computer system of claim 9, wherein the signal to transfer the executing application includes signals generated by a mouse, keyboard, keypad, capacitive touchscreen, or motion sensing input device.

17. A computer program product to transfer an executing application to a second computer, the computer program product comprising:
one or more computer-readable storage devices and program instructions stored on at least one of the one or more storage devices, the program instructions comprising:
program instructions to halt an executing application on a first computer, wherein the first computer is executing a first cross-platform hypervisor, and wherein the executing application includes a graphical state and a memory state;
program instructions to receive a signal to transfer the executing application to a second computer, wherein the second computer is executing a second cross-platform hypervisor;
program instructions to transfer the graphical state of the executing application to the second computer, wherein the transfer of the graphical state may utilize any suitable protocol capable of transferring the graphical state of the executing application from the first computer to the second computer; and
program instructions to transfer the memory state of the executing application to the second computer, wherein the transfer of the memory state may utilize any suitable protocol capable of transferring the memory state of the application from the first computer to the second computer, and wherein execution of the executing application resumes on the second computer.

18. The computer program product of claim 17, wherein the first cross-platform hypervisor is a virtualization manager that is able to emulate at least a portion of the executing application's native executing environment.

19. The computer program product of claim 18, wherein the portion of the executing application's native executing environment includes an input/output system, graphics driver, hardware interface, processor or storage.

20. The computer program product of claim 17, wherein the first cross-platform hypervisor is operating system agnostic.

21. The computer program product of claim 17, wherein the first cross-platform hypervisor is identical to or compatible with the second cross-platform hypervisor.

22. The computer program product of claim 17, wherein the graphical state of the executing application includes a plurality of graphical icons and/or visual indicators that present information and available actions to a user.

23. The computer program product of claim 17, wherein the memory state of the executing application includes information pertaining to a running state of the executing application.

24. The computer program product of claim 17, wherein the signal to transfer the executing application includes signals generated by a mouse, keyboard, keypad, capacitive touchscreen or motion sensing input device.
